(19) United States
(12) Patent Application Publication
(10) Pub. No.: US 2015/0349882 A1
(43) Pub. Date: Dec. 3, 2015

(54) WIRELESS DATA COMMUNICATION USING AIRBORNE LIGHTING AND GROUND SUPPORT SYSTEMS

(71) Applicant: Honeywell International Inc., Morristown, NJ (US)

(72) Inventors: Andrew Fannon Lamkin, Albuquerque, NM (US); Joseph Nutaro, Phoenix, AZ (US); Duke Buster, Albuquerque, NM (US); Craig Giffen, Hilliard, OH (US)

(73) Assignee: Honeywell International Inc., Morristown, NJ (US)

(21) Appl. No.: 14/287,844

(22) Filed: May 27, 2014

(51) Int. Cl. H04B 10/112; H04B 10/40

(52) U.S. Cl. CPC H04B 10/112; H04B 10/40

(57) ABSTRACT

A system for wireless optical data communications comprises a first gateway device including a processor onboard a first aircraft, and a first set of light sources onboard the aircraft in operative communication with the gateway device. The light sources comprise a plurality of light emitting diodes. A first optical receiver is onboard the aircraft and in operative communication with the gateway device. In a transmission mode, the gateway device is configured to monitor a databus onboard the aircraft for digital data selected for wireless optical transmission, encode the digital data selected for wireless optical transmission with a compatible optical modulation scheme, and broadcast the encoded digital data through modulated light emitted from the set of light sources. In a reception mode, the gateway device is configured to decode digital data from modulated light captured by the optical receiver from a wireless optical transmission from the ground or another aircraft.

### BACKGROUND

As aircraft radio frequency space gets increasingly more crowded, new safety and positioning systems need to expand to other frequency spaces to minimize interference and increase reliability. Thus, there is a need for a secondary or backup paradigm for transmitting and receiving data on aircraft.

### SUMMARY

A system for wireless optical data communications comprises a first gateway device including a processor onboard a first aircraft, and a first set of light sources onboard the aircraft in operative communication with the gateway device. The light sources comprise a plurality of light emitting diodes. A first optical receiver is onboard the aircraft and in operative communication with the gateway device. In a transmission mode, the gateway device is configured to monitor a databus onboard the aircraft for digital data selected for wireless optical transmission, encode the digital data selected for wireless optical transmission with a compatible optical modulation scheme, and broadcast the encoded digital data through modulated light emitted from the set of light sources. In a reception mode, the gateway device is configured to decode digital data from modulated light captured by the optical receiver from a wireless optical transmission from the ground or another aircraft.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1 is a block diagram of a system for wireless data communications between aircraft and the ground, according to one embodiment;

FIG. 2 is a block diagram of a system for wireless data communications between aircraft, according to another embodiment;

FIG. 3A is a block diagram of a method for wireless data communications between an unmanned aerial vehicle and the ground, according to one embodiment;

FIG. 3B is a block diagram of a method for wireless data communications between multiple unmanned aerial vehicles, according to another embodiment;

FIG. 4 is a block diagram of a method for wireless data communications between an aircraft and the ground, according to one embodiment; and

FIG. 5 is a block diagram of a method for wireless data communications between aircraft, and between the aircraft and a ground vehicle, according to another embodiment.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

A system and method for wireless optical data communications is provided that uses airborne lighting and ground support systems. The system provides an interface to an existing aircraft databus and aircraft lighting for data translation and light modulation using standard optical modulation paradigms. The data can then be transmitted wirelessly between aircraft and ground stations across an optical medium. For example, digital modulation of existing aircraft lights that include light emitting diodes (LEDs) can be used to transmit digital data through the emitted light. The LEDs employed in the present technique can include those that emit visible light or infrared light.

By utilizing the properties of the LEDs installed on aircraft, wireless data can be transmitted to ground-based or air-based receivers. This is accomplished by modulating the LED lights incorporated in a lighting module using any number of standard digital modulation techniques to encode and transmit the data. The data can be transmitted during normal use of conventional LED aircraft lights, such as landing lights, navigation lights, anti-collision lights, engine run lights, strobe lights, beacon lights, or the like. The present approach can be applied to various types of aircraft, including manned aircraft, and unmanned aerial vehicles (UAVs).

The present method can be carried out without adversely affecting the primary function of the aircraft lighting system, and can be effective without impacting the required brightness levels and fields of view. The light carrying the data can be received with a standard optical detector, such as a photodiode or electro optical camera, which has a clear view of the transmitting light source.

The present system provides gateway hardware and cabling that enables compatible aircraft lighting systems to transmit and receive wireless optical data over lights normally installed in the aircraft without affecting their normal operation, including navigation/position, landing, and anti-collision lights. This system can be provided as a retrofit kit or incorporated into new designs natively. For example, the present system can be implemented in a retrofit using existing aircraft anti collision, position, or exterior lighting.

The gateway hardware listens for data items from the aircraft data bus (selected at installation by a user) by monitoring the data bus, reads the data, and then stores the data for transmission. The gateway hardware then translates the stored data into a format compatible with optical media transmission. This data is then broadcast using a compatible modulation scheme (e.g., orthogonal frequency-division multiplexing (OFDM), on-off keying, frequency modulation (FM), amplitude modulation (AM)) across a plurality of LED hardware configurations, including LED aircraft position and anti-collision lights. An optical detector in a fixed location or handheld receiver, remotely located from the aircraft, captures the data via the wireless optical media transmissions. The received data can then be provided over a digital bus or standard data transport protocols.

An optical receiver can be co-located with other existing aircraft lights, configured to transmit digital data, in an optical transponder configuration that both sends and receives digital data, such as aircraft position and identification information. The optical receiver can be implemented with available dynamic amplification to account for a variety of reception conditions.

Since even high frequency modulation of an LED can cause a decrease in overall brightness, regulated minimums for brightness need to be taken into account when using aircraft lighting to broadcast wireless optical data. Accordingly, a software algorithm can be employed to monitor the brightness levels of aircraft lighting, and ensure that any wireless data transmissions going across the aircraft lighting do not cause the brightness levels to fall below government mandated predefined thresholds. This is accomplished by inputting the required brightness levels into the gateway hardware. The software then can dynamically adjust data throughput to maintain minimum brightness levels. Alternatively, the gateway hardware can be fitted with a feedback loop such as a photodiode (e.g., a photodiode that is part of a data receive circuit). This feedback loop can provide brightness levels directly back to the gateway hardware, which can then adjust the data rates and frequencies.

In addition, a software algorithm can be employed to transmit data only during pre-existing flashes of aircraft lights. Some aircraft lights such as the anti-collision strobe have mandated flash intervals that must be maintained for regulatory compliance. The gateway hardware can take these flash intervals into account when transmitting data over the lights by breaking the data streams up into compatible messages suited for the particular interval of the flashing light being employed.

The present method can be used for broadcasting digital aircraft position and identification information wirelessly over existing aircraft lights to support air to ground telemetry, air-ground message passing, aircraft to aircraft collision avoidance, aircraft to ground vehicle collision avoidance, air to air telemetry, or air to air message passing.

Further details of the present method and system are described hereafter with reference to the drawings.

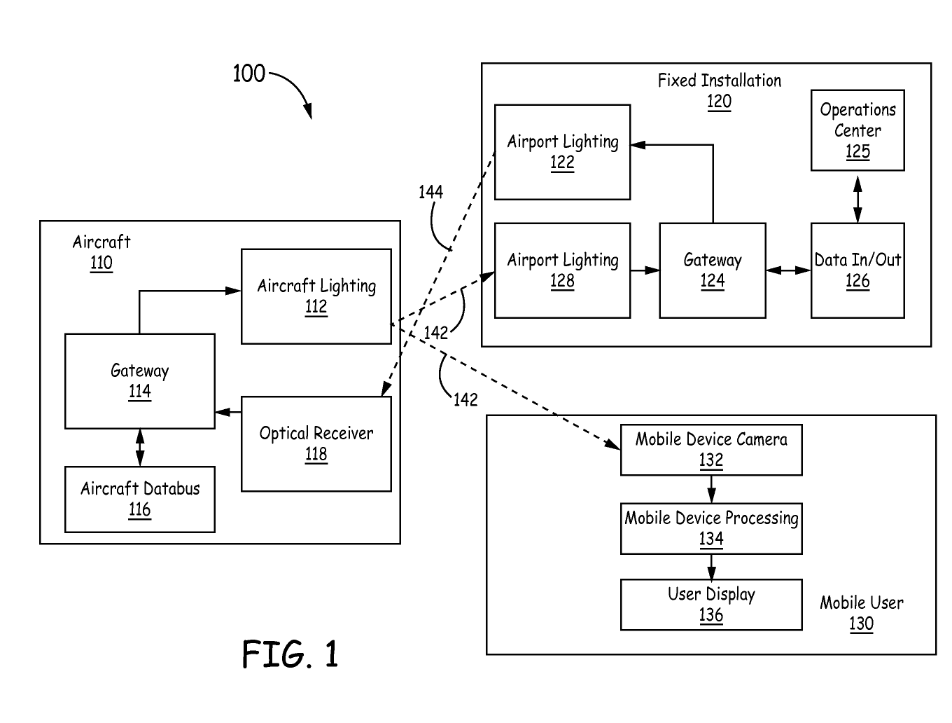

FIG. 1 illustrates a wireless data communications system 100 according to one embodiment, which employs aircraft or airport lighting as a data communications medium. The system 100 is configured for data communications between an aircraft 110 and a fixed ground installation 120, or between aircraft 110 and a mobile ground user 130. The system 100 can employ one or more aircraft lighting sources 112, such as navigation lights, strobes lights, or beacon lights, for example. The lighting sources 112 include a plurality of light emitting diodes that emit non-coherent light as an optical data transmission medium.

The aircraft lighting sources 112 are in operative communication with an aircraft gateway device 114, which includes at least one processor. An aircraft databus 116 is in operative communication with gateway device 114. The aircraft databus can be a standard databus, such as a 1553 databus, an RS-232 databus, Ethernet, or the like.

An aircraft optical receiver 118 is also in operative communication with gateway device 114. In one embodiment, optical receiver 118 is co-located with one of the lighting sources 112 in an optical transponder configuration. The optical receiver 118 can include a photodiode or camera, for example.

In one embodiment, the processor in gateway device 114 is configured to execute program instructions for a software algorithm to monitor brightness levels of lighting sources 112, and adjust encoded digital data throughput to lighting sources 112 to maintain the brightness levels above a predefined threshold. In one implementation, the brightness levels can be monitored with a feedback loop from optical receiver 118 to gateway device 114 when optical receiver 118 is co-located with one of lighting sources 112. In another embodiment, gateway device 114 can be configured to store the digital data prior to the digital data being encoded, and broadcast the encoded digital data only during pre-existing flashes of light emitted by lighting sources 112.

The fixed ground installation 120, such as an airport, includes one or more airport lighting sources 122, which can be an aerodrome beacon, runway/taxiway perimeter lighting, or a dedicated wireless optical data installation, for example. The airport lighting sources 122 are in operative communication with an airport gateway device 124. The gateway device 124 communicates with an operations center 125, such as air traffic control (ATC), through a data input/output (I/O) interface 126. The I/O interface 126 can be configured for Ethernet, WiFi, Bluetooth, RS232, a cellular network, or the like. An optical receiver 128 is also in operative communication with gateway device 124.

The mobile ground user 130 can include a mobile device camera 132, a mobile device processing unit 134 in operative communication with camera 132, and a user display 136 in operative communication with processing unit 134.

During operation of system 100 for data transmission from aircraft 110, gateway device 114, while in a transmission mode, monitors databus 116 for digital data selected for wireless optical transmission, and encodes the selected digital data with a compatible optical modulation scheme. The encoded digital data is then broadcasted through modulated light emitted from the lighting sources 112 as the transmission medium (indicated as arrow 142).

The digital data transmitted through the modulated light (142) from lighting sources 112 can be captured by optical receiver 128 in fixed ground installation 120. The optical receiver 128 converts the light to electrical transmission signals that are sent to gateway device 124 for demodulation of the transmission signals. The demodulated signals are then sent to operations center 125 through I/O interface 126.

The digital data transmitted through the modulated light (142) from lighting sources 112 can also be captured by camera 132 of mobile ground user 130. The received transmission data can be processed in mobile device processing unit 134, and the transmission data can then be output to user display 136.

During operation of system 100 for data reception by aircraft 110, gateway device 124 receives digital data output from operations center 125. The gateway device 124 employs digital modulation techniques to transmit the digital data using light from airport lighting sources 122 as the transmission medium. The digital data is transmitted through modulated light (144) emitted from lighting sources 122, and captured by optical receiver 118 in aircraft 110. The optical receiver 118 converts the modulated light to electrical signals that are sent to gateway device 114, which in a reception mode, decodes the digital data from the converted modulated light. The decoded digital data is then sent to aircraft databus 116, which routes the digital data to one or more onboard avionics devices.

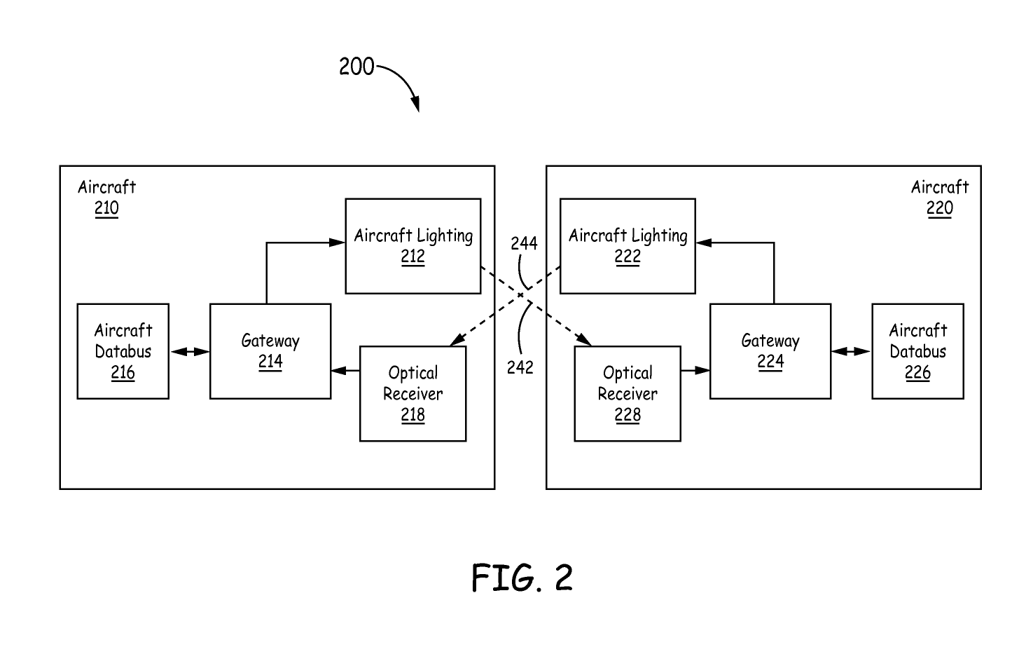

FIG. 2 illustrates a wireless data communications system 200 according to another embodiment, which employs aircraft lighting as a data communications medium. The system 200 is configured for bidirectional data communications between aircraft, such as a first aircraft 210 and a second aircraft 220.

The aircraft 210 has a set of aircraft lighting sources 212, such as navigation lights, strobes lights, or beacon lights, which include a plurality of LEDs. The aircraft lighting sources 212 are in operative communication with a gateway device 214 onboard aircraft 210. An aircraft databus 216 is in operative communication with gateway device 214. An optical receiver 218 is also in operative communication with gateway device 214.

Similarly, aircraft 220 has a set of aircraft lighting sources 222 that include a plurality of LEDs. The aircraft lighting sources 222 are in operative communication with a gateway device 224 onboard aircraft 220. An aircraft databus 226 is in operative communication with gateway device 224. An optical receiver 228 is also in operative communication with gateway device 214.

The foregoing components in aircraft 210 and 220 can have the same functions and configurations as described above for the corresponding components in aircraft 110 of FIG. 1.

During operation of system 200 for data transmission from aircraft 210 to aircraft 220, gateway device 214 monitors aircraft databus 216 for digital data selected for wireless optical transmission, and encodes the selected digital data with a compatible optical modulation scheme. The encoded digital data is then broadcasted through modulated light emitted from lighting sources 212 as the transmission medium (indicated as arrow 242). The digital data transmitted through the modulated light (242) is captured by optical receiver 228 in aircraft 220. The optical receiver 228 converts the modulated light to electrical transmission signals that are sent to gateway device 224, which decodes the digital data from the converted modulated light. The decoded digital data is then sent to aircraft databus 226, which routes the signals to one or more onboard avionics devices.

Likewise, during operation of system 200 for data transmission from aircraft 220 to aircraft 210, gateway device 224 monitors aircraft databus 226 for digital data selected for wireless optical transmission, and encodes the selected digital data with a compatible optical modulation scheme. The encoded digital data is then broadcasted through modulated light emitted from lighting sources 222 as the transmission medium (indicated as arrow 244). The digital data transmitted through the modulated light (244) is captured by optical receiver 218 in aircraft 210. The optical receiver 218 converts the modulated light to electrical transmission signals that are sent to gateway device 214, which decodes the digital data from the converted modulated light. The decoded digital data is then sent to aircraft databus 216, which routes the signals to one or more onboard avionics devices.

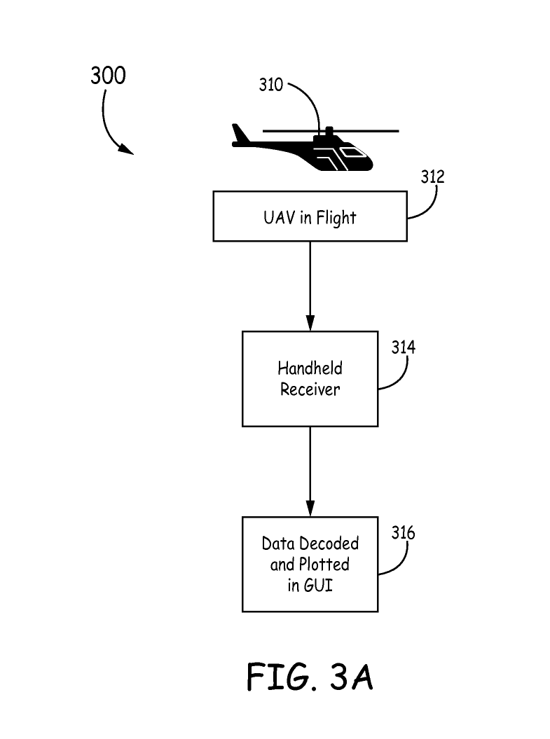

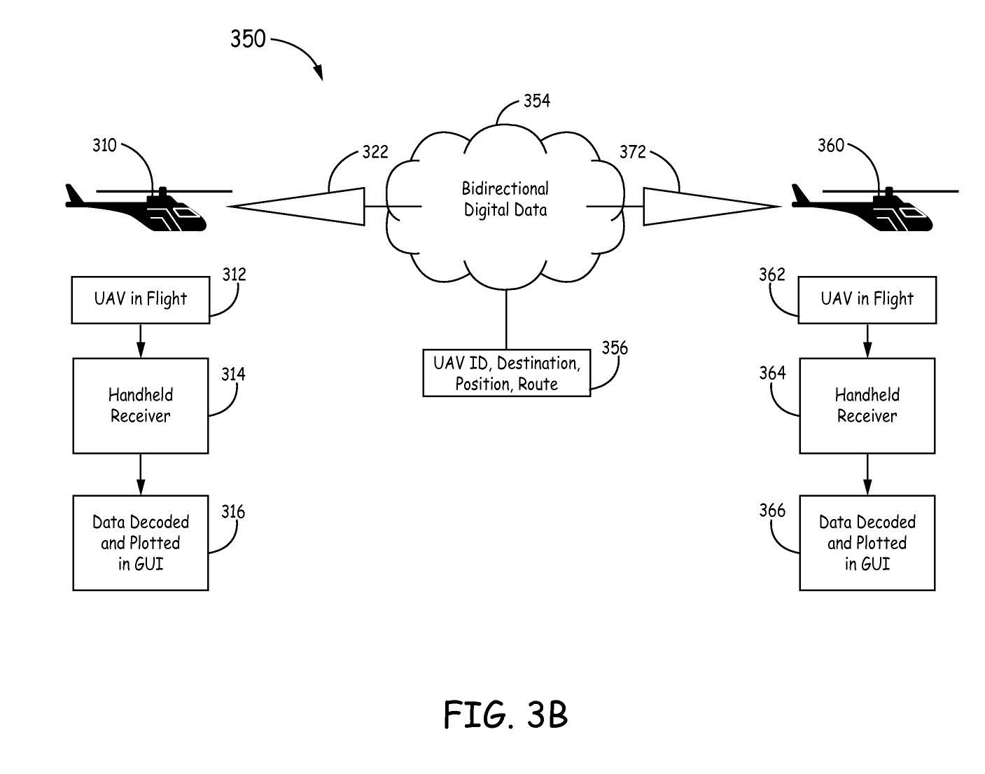

FIG. 3A illustrates an exemplary wireless data communications method 300 for use in unmanned aerial vehicle (UAV) to ground communications. A UAV 310 in flight (block 312) has various LED light sources, such as anti-collision lights, navigation lights, or special UAV light beacons used for ground identification of the UAV, which are configured to emit modulated light. The light from the light sources is modulated to encode digital data, such as UAV identification data, destination data, positioning data, route data, and the like. The modulated light from UAV 310 is received by a handheld receiver that can also decode the digital data from the UAV lighting modulation (block 314). The received data is decoded and plotted on a display such as a graphical user interface (GUI) (block 316). The hand held receiver can be implemented in a mobile computing device, such as a smart phone, tablet computer, or the like, which can receive flashes of data information.

For example, when a handheld device with an optical receiver is pointed at a UAV having visible anti-collision lights used for transmitting light modulations that encode digital data, the optical receiver can receive a burst of digital data from the light modulations listing identification data, positioning data, and route data for the UAV. The light modulations are converted into digital data and displayed to a user on a GUI. In this way the UAV can be identified without requiring complex digital radios that such aircraft typically employ for their telemetry and control links.

This approach can be used to record and identify the UAV and the UAV location as spotted by an observer. This method can be used as a lightweight, low cost alternative to a full transponder for national airspace operation, and can be used as a backup identification method for the public, law enforcement, and other observers. This is an inexpensive way for people on the ground to monitor and report a UAV illegally flying in an area and provide accountability for mishaps.

FIG. 3B illustrates an exemplary method 350 for wireless data transmission between two or more UAVs, which can be applied for navigation and communication among the UAVs. For example, the method 350 can be implemented for UAV 310 in flight (block 312), described with respect to FIG. 3A, and another UAV 360 that is also in flight (block 362). As described previously, UAV 310 has various LED light sources, which are configured to emit modulated light 322 as shown in FIG. 3B. The UAV 360 also has various LED light sources, which are configured to emit modulated light 372. Bidirectional digital data 354 can be exchanged between UAV 310 and UAV 360 via the modulation of the LED light sources on each UAV. The light from each of the LED light sources is modulated to encode digital data, such as UAV identification (ID) data, destination data, position data, route data, and the like (block 356). The modulated light 322 from UAV 310 can be captured by an optical receiver UAV 360. Likewise, modulated light 372 from UAV 360 can be captured by an optical receiver on UAV 310.

As described above, modulated light from UAV 310 can be received by a handheld receiver that can also decode the digital data from the UAV lighting modulation (block 314), and the received data is decoded and plotted on a display such as a GUI (block 316). Similarly, modulated light from UAV 360 can be received by a handheld receiver that can also decode the digital data from the UAV lighting modulation (block 364), and the received data is decoded and plotted on a display such as a GUI (block 366).

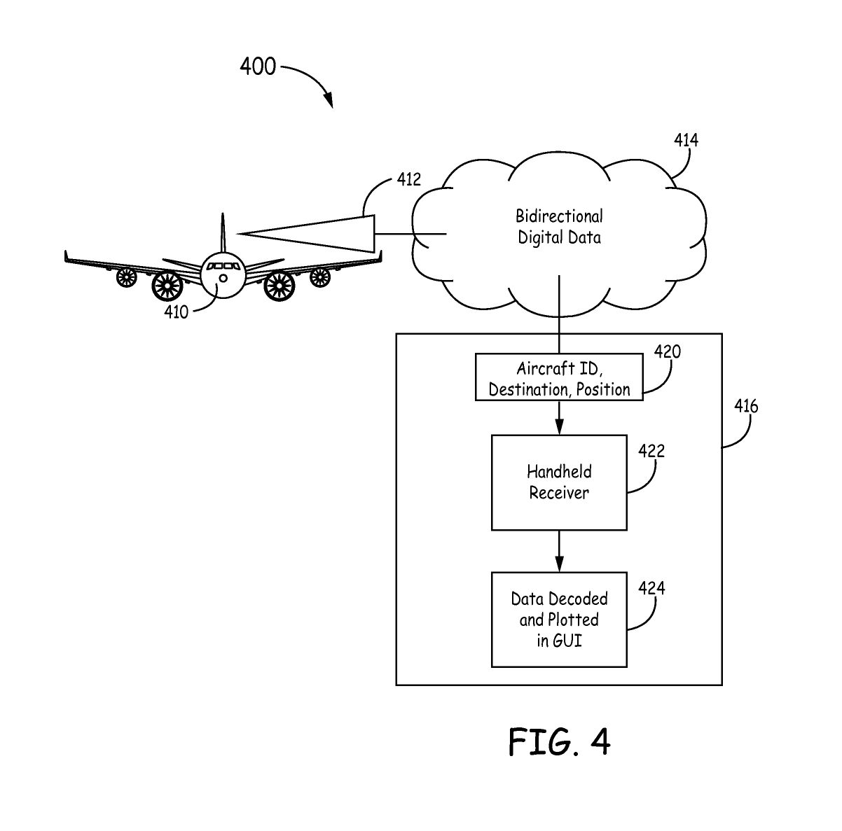

FIG. 4 illustrates an exemplary wireless data communications method 400 for use in aircraft to ground communications. An aircraft 410 has various LED light sources, such as described previously, which are configured to emit modulated light 412. Bidirectional digital data 414 can be exchanged between aircraft 410 and a ground receiver (block 416) via the aircraft lighting modulation.

For example, modulated light 412 from aircraft 410 can be encoded with digital data such as aircraft identification data, destination data, position data, and the like (block 420). The modulated light 412 is captured by an optical receiver on a handheld device (block 422), which is pointed at aircraft 410. The received light modulations with the digital data is then decoded and plotted in a GUI (block 424) for display to a user. This method can be used as a backup to a transponder, or as a secondary wireless identification method. This approach can also be used to enable air traffic controllers to view aircraft information overlaid on an augmented reality type display.

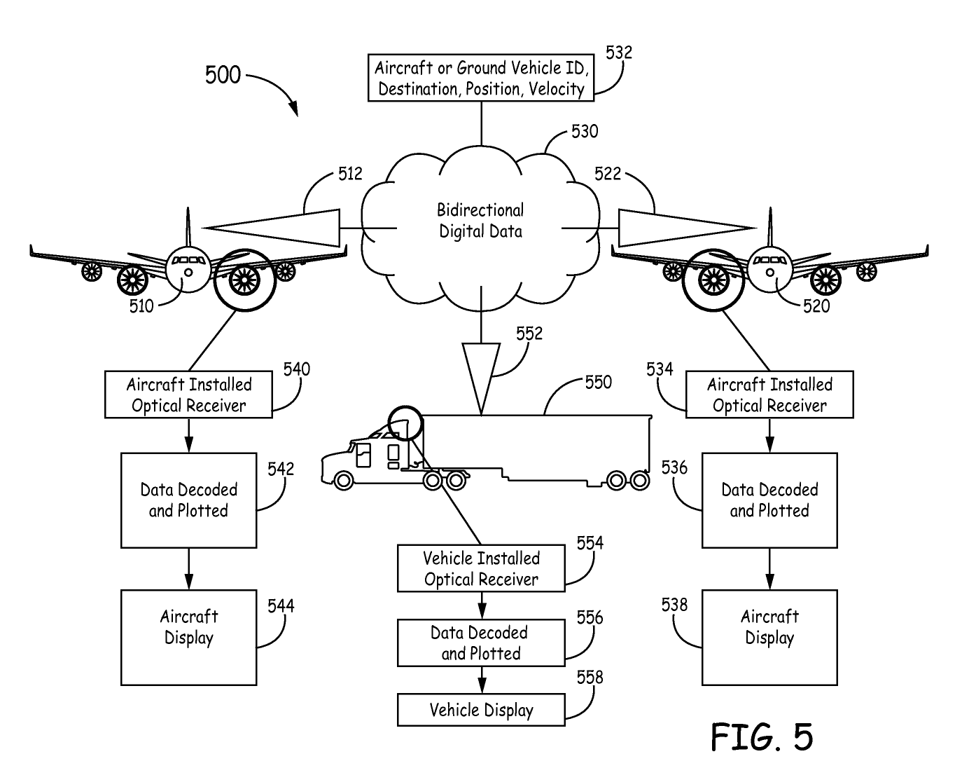

FIG. 5 illustrates an exemplary wireless data communications method 500, which can be used in aircraft to aircraft communications, or aircraft to ground vehicle communications. The method 500 can be used for light based data transmission of supplementary data, such as anti-collision information.

In using method 500 in aircraft to aircraft communications, both aircraft can be in flight, or both aircraft can be on the ground. For example, an aircraft 510 can have various LED light sources, which are configured to emit modulated light 512. Likewise, an aircraft 520 can also have various LED light sources, which are configured to emit modulated light 522. Bidirectional digital data 530 can be exchanged between aircraft 510 and aircraft 520 via the aircraft lighting modulation from each aircraft. The modulated light can be encoded with digital data such as aircraft ID data, destination data, position data, velocity data, and the like (block 532).

The modulated light 512 from aircraft 510 is captured by an optical receiver installed on aircraft 520 (block 534). The received light modulations with the digital data is then decoded and plotted (block 536) for viewing on an aircraft display (block 538). Likewise, modulated light 522 from aircraft 520 is captured by an optical receiver installed on aircraft 510 (block 540). The received light modulations with the digital data is then decoded and plotted (block 542) for viewing on an aircraft display (block 544).

In using method 500 in aircraft to ground vehicle communications, the aircraft is on the ground. A ground vehicle 550 can have various LED light sources, which are configured to emit modulated light 552. Bidirectional digital data 530 can be exchanged between aircraft 510 and ground vehicle 550 via the lighting modulation from aircraft 510 and ground vehicle 550. The modulated light can be encoded with digital data such as aircraft ID data, ground vehicle ID data, position data, velocity data, and the like (block 532). The modulated light 512 from aircraft 510 is captured by an optical receiver installed on vehicle 550 (block 554). The received light modulations with the digital data is then decoded and plotted (block 556) for viewing on a vehicle display (block 558). Likewise, modulated light 552 from ground vehicle 550 is captured by the optical receiver installed on aircraft 510 (block 540). The received light modulations with the digital data is then decoded and plotted (block 542) for viewing on the aircraft display (block 544).

In a similar fashion, bidirectional digital data 530 can be exchanged between aircraft 520 and ground vehicle 550 via the lighting modulation from aircraft 520 and ground vehicle 550. The modulated light 522 from aircraft 510 is captured by the optical receiver on vehicle 550 (block 554). The received light modulations with the digital data is then decoded and plotted (block 556) for viewing on a vehicle display (block 558). Likewise, modulated light 552 from ground vehicle 550 is captured by the optical receiver on aircraft 520 (block 534). The received light modulations with the digital data is then decoded and plotted (block 536) for viewing on the aircraft display (block 538).

A computer or processor used in the present system and method can be implemented using software, firmware, hardware, or any appropriate combination thereof, as known to one of skill in the art. These may be supplemented by, or incorporated in, specially-designed application-specific integrated circuits (ASICs) or field programmable gate arrays (FPGAs). The computer or processor can also include functions with software programs, firmware, or other computer readable instructions for carrying out various process tasks, calculations, and control functions used in the present method and system.

The present methods can be implemented by computer executable instructions, such as program modules or components, which are executed by at least one processor. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein can be implemented in software, firmware, or other computer- or processor-readable instructions. These instructions are typically stored on any appropriate computer program product that includes a computer readable medium used for storage of computer readable instructions or data structures. Such a computer readable medium can be any available media that can be accessed by a general purpose or special purpose computer or processor, or any programmable logic device.

Suitable processor-readable media may include storage or memory media such as magnetic or optical media. For example, storage or memory media may include conventional hard disks, compact disks, DVDs, Blu-ray discs, or other optical storage disks; volatile or non-volatile media such as Random Access Memory (RAM); Read Only Memory (ROM), Electrically Erasable Programmable ROM (EEPROM), flash memory, and the like; or any other media that can be used to carry or store desired program code in the form of computer executable instructions or data structures.

### Example Embodiments

Example 1 includes a system for wireless optical data communications, the system comprising: a first gateway device including at least one processor onboard a first aircraft; a first set of light sources onboard the first aircraft and in operative communication with the first gateway device, the first set of light sources comprising a plurality of light emitting diodes; and a first optical receiver onboard the first aircraft and in operative communication with the first gateway device. In a transmission mode, the first gateway device is configured to monitor a databus onboard the first aircraft for digital data selected for wireless optical transmission, encode the digital data selected for wireless optical transmission with a compatible optical modulation scheme, and broadcast the encoded digital data through modulated light emitted from the first set of light sources. In a reception mode, the first gateway device is configured to decode digital data from modulated light captured by the first optical receiver from a wireless optical transmission from the ground or another aircraft.

Example 2 includes the system of Example 1, wherein the light sources comprise aircraft anti-collision lights, aircraft navigation lights, strobes lights, or beacon lights.

Example 3 includes the system of any of Examples 1-2, wherein the first optical receiver is co-located with one of the light sources in an optical transponder configuration.

Example 4 includes the system of any of Examples 1-3, wherein the first optical receiver comprises a photodiode or a camera.

Example 5 includes the system any of Examples 1-4, wherein the first gateway device is further configured to monitor brightness levels of the light sources, and adjust the encoded digital data throughput to the light sources to maintain the brightness levels above a predefined threshold.

Example 6 includes the system of Example 5, wherein the brightness levels are monitored with a feedback loop from the first optical receiver to the first gateway device.

Example 7 includes the system of any of Examples 1-6, wherein the first gateway device is further configured to store the digital data prior to the digital data being encoded, and broadcast the encoded digital data only during pre-existing flashes of light emitted by the light sources.

Example 8 includes the system of any of Examples 1-7, further comprising: a second gateway device; a second set of light sources in operative communication with the second gateway device, the second set of light sources comprising a plurality of light emitting diodes; and a second optical receiver in operative communication with the second gateway device. In a transmission mode, the second gateway device is configured to encode digital data selected for wireless optical transmission with a compatible optical modulation scheme, and broadcast the encoded digital data through modulated light emitted from the second set of light sources. In a reception mode, the second gateway device is configured to decode digital data from the modulated light emitted from the first set of light sources onboard the first aircraft and captured by the second optical receiver.

Example 9 includes the system of Example 8, wherein the second gateway device, the second set of light sources, and the second optical receiver are located in a fixed ground installation.

Example 10 includes the system of Examples 8, wherein the second gateway device, the second set of light sources, and the second optical receiver are located onboard a second aircraft.

Example 11 includes the system of any of Examples 1-10, further comprising a handheld receiver configured to capture the broadcasted modulated light encoded with the digital data, decode the digital data from the modulated light, and display the decoded digital data to a user.

Example 12 includes a method of wireless optical data communications, the method comprising: monitoring a databus onboard a first aircraft for digital data selected for wireless optical transmission; encoding the digital data selected for wireless optical transmission with a compatible optical modulation scheme; broadcasting the encoded digital data through modulated light emitted from a first set of light sources onboard the aircraft, the first set of light sources comprising a plurality of light emitting diodes; receiving the modulated light in an optical receiver remotely located from the first aircraft; decoding the digital data from the received modulated light; and displaying the decoded digital data.

Example 13 includes the method of Example 12, wherein the optical receiver is located in a fixed ground installation.

Example 14 includes the method of Example 12, wherein the optical receiver is located in a mobile device operated by a user on the ground.

Example 15 includes the method of Example 12, wherein the optical receiver is located in a second aircraft.

Example 16 includes the method of any of Examples 12-15, wherein the first aircraft comprises an unmanned aerial vehicle.

Example 17 includes the method of any of Examples 12-16, further comprising storing the digital data prior to encoding the digital data selected for wireless optical transmission.

Example 18 includes the method of any of Examples 12-17, wherein the encoded digital data supports air to ground telemetry, air-ground message passing, aircraft to aircraft collision avoidance, aircraft to ground vehicle collision avoidance, air to air telemetry, or air to air message passing.

Example 19 includes the method of any of Examples 12-18, wherein the encoded digital data is broadcast using a modulation technique comprising orthogonal frequency-division multiplexing, on-off keying, frequency modulation, or amplitude modulation.

Example 20 includes the method of any of Examples 12-19, wherein the decoded digital data is displayed on a graphical user interface.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A system for wireless optical data communications, the system comprising:
a first gateway device including at least one processor onboard a first aircraft;
a first set of light sources onboard the first aircraft and in operative communication with the first gateway device, the first set of light sources comprising a plurality of light emitting diodes; and
a first optical receiver onboard the first aircraft and in operative communication with the first gateway device;
wherein in a transmission mode, the first gateway device is configured to:
monitor a databus onboard the first aircraft for digital data selected for wireless optical transmission;
encode the digital data selected for wireless optical transmission with a compatible optical modulation scheme; and
broadcast the encoded digital data through modulated light emitted from the first set of light sources;
wherein in a reception mode, the first gateway device is configured to:
decode digital data from modulated light captured by the first optical receiver from a wireless optical transmission from the ground or another aircraft.

2. The system of claim 1, wherein the light sources comprise aircraft anti-collision lights, aircraft navigation lights, strobes lights, or beacon lights.

3. The system of claim 1, wherein the first optical receiver is co-located with one of the light sources in an optical transponder configuration.

4. The system of claim 1, wherein the first optical receiver comprises a photodiode or a camera.

5. The system claim 1, wherein the first gateway device is further configured to:
monitor brightness levels of the light sources; and
adjust the encoded digital data throughput to the light sources to maintain the brightness levels above a predefined threshold.

6. The system of claim 5, wherein the brightness levels are monitored with a feedback loop from the first optical receiver to the first gateway device.

7. The system of claim 1, wherein the first gateway device is further configured to store the digital data prior to the digital data being encoded, and broadcast the encoded digital data only during pre-existing flashes of light emitted by the light sources.

8. The system of claim 1, further comprising:
a second gateway device;
a second set of light sources in operative communication with the second gateway device, the second set of light sources comprising a plurality of light emitting diodes; and
a second optical receiver in operative communication with the second gateway device;
wherein in a transmission mode, the second gateway device is configured to:
encode digital data selected for wireless optical transmission with a compatible optical modulation scheme; and
broadcast the encoded digital data through modulated light emitted from the second set of light sources;
wherein in a reception mode, the second gateway device is configured to:
decode digital data from the modulated light emitted from the first set of light sources onboard the first aircraft and captured by the second optical receiver.

9. The system of claim 8, wherein the second gateway device, the second set of light sources, and the second optical receiver are located in a fixed ground installation.

10. The system of claim 8, wherein the second gateway device, the second set of light sources, and the second optical receiver are located onboard a second aircraft.

11. The system of claim 1, further comprising a handheld receiver configured to:
capture the broadcasted modulated light encoded with the digital data;
decode the digital data from the modulated light; and
display the decoded digital data to a user.

12. A method of wireless optical data communications, the method comprising:
monitoring a databus onboard a first aircraft for digital data selected for wireless optical transmission;
encoding the digital data selected for wireless optical transmission with a compatible optical modulation scheme;
broadcasting the encoded digital data through modulated light emitted from a first set of light sources onboard the aircraft, the first set of light sources comprising a plurality of light emitting diodes;
receiving the modulated light in an optical receiver remotely located from the first aircraft;
decoding the digital data from the received modulated light; and
displaying the decoded digital data.

13. The method of claim 12, wherein the optical receiver is located in a fixed ground installation.

14. The method of claim 12, wherein the optical receiver is located in a mobile device operated by a user on the ground.

15. The method of claim 12, wherein the optical receiver is located in a second aircraft.

16. The method of claim 12, wherein the first aircraft comprises an unmanned aerial vehicle.

17. The method of claim 12, further comprising storing the digital data prior to encoding the digital data selected for wireless optical transmission.

18. The method of claim 12, wherein the encoded digital data supports air to ground telemetry, air-ground message passing, aircraft to aircraft collision avoidance, aircraft to ground vehicle collision avoidance, air to air telemetry, or air to air message passing.

19. The method of claim 12, wherein the encoded digital data is broadcast using a modulation technique comprising orthogonal frequency-division multiplexing, on-off keying, frequency modulation, or amplitude modulation.

20. The method of claim 12, wherein the decoded digital data is displayed on a graphical user interface.
